(19) United States
(12) Patent Application Publication
(10) Pub. No.: US 2004/0221743 A1
(43) Pub. Date: Nov. 11, 2004

(54) Baking tray for bread maker

(75) Inventors: Jae-ryong Park, Suwon-city (KR); Yong-hyun Kwon, Suwon-city (KR); Chul Kim, Anyang-city (KR); Tae-uk Lee, Suwon-city (KR); Han-Jun Sung, Suwon-city (KR); Jang-woo Lee, Suwon-city (KR); Dong-bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/813,126

(22) Filed: Mar. 31, 2004

(30) Foreign Application Priority Data
May 7, 2003 (KR) 2003-29086

(51) Int. Cl. A23L 1/00

(52) U.S. Cl. 99/348

(57) ABSTRACT

The present invention relates to a baking tray for bread maker, and more particularly to a baking tray for a bread maker formed with a non-sticky ceramic layer. Thus, the baking tray in which impact given by the mixing bag moved up and down can be absorbed and which is more sanitary is offered.

### CROSS-REFERENCE TO RELATED APPLICATIONS

This application claims the benefit of Korean Patent Application No. 2003-029086, filed May 7, 2003, in the Korean Intellectual Property Office, the disclosure of which is incorporated herein by reference.

### BACKGROUND OF THE INVENTION

1. Field of the Invention

The present invention relates to a baking tray for bread maker, and more particularly to a baking tray for a bread maker formed with a non-sticky ceramic layer.

2. Description of the Related Art

Conventionally, various bread makers have been developed to allow a user to easily make bread by automatically performing multiple steps such as kneading, leavening and baking of raw materials to provide finished bread to the user.

Typically, a bread maker in which dough is kneaded by reciprocating a mixing bag up and down includes: an oven compartment; a pair of parallel kneading drums which are rotatably disposed in upper and lower parts of the oven compartment and rotated in clockwise and counterclockwise directions; a baking tray which is placed between the upper and lower kneading drums and formed with a slit; a pair of dough-blocking members which is disposed in an upper part of the oven compartment between the baking tray and the upper kneading drum and prevents the mixing bag from being moved toward the upper kneading drum; a heater to heat the inside of the oven compartment; a rotation sensor sensing rotations of the upper and lower kneading drums; a driving part rotating the upper and lower kneading drums; and a control part controlling a rotation of the upper and lower kneading drums.

A baking process of the bread maker is described as follows. Upper and lower ends of the mixing bag which contains raw materials for bread are wound by the pair of kneading drums and then the mixing bag is reciprocated for a predetermined period of time by rotation of the upper and lower kneading drums, so that dough is kneaded in the mixing bag.

Thereafter, only the lower kneading drum is rotated, and the kneaded dough in the mixing bag moves into the baking tray. Then, the heater heats the inside of the oven compartment, thereby making bread in the baking tray by leavening and baking the kneaded raw materials for a predetermined period of time.

When bread making is completed, the bread should be smoothly separated from the baking tray. However, the separation is not easy, because the bread sticks inside of the baking tray. Therefore, it is required that inner surfaces of the baking tray be coated so that the finished bread can be easily separated from the baking tray. However, in the above-described bread maker, the dough in the mixing bag is kneaded by rotating the upper and lower kneading drums and the mixing bag repeatedly strikes the baking tray during a kneading process by being reciprocated up and down. Thus, if a coating layer has bad abrasion resistance, it may be damaged and removed by the repeated strikes, thereby rising a sanitary problem. Further, a repetitive usage of the baking tray makes the coating layer sticky and requires a forced separation of the bread and the baking tray, so that the shape of the finished bread may be deformed. Hence, a baking tray whose inner surfaces are coated with non-sticky material having good abrasion resistance is required.

Here, the term “non-sticky” has the meaning that the bread does not stick to the baking tray and can be easily separated therefrom.

### SUMMARY OF THE INVENTION

Accordingly, it is an aspect of the present invention to provide a bread maker formed with a non-sticky ceramic layer inside thereof.

The foregoing and/or other aspects of the present invention are achieved by providing a baking tray for use in a bread maker, the baking tray having surfaces coated with a non-sticky ceramic layer.

According to an aspect of the invention, the non-sticky ceramic layer is coated on an inner surface of the baking tray.

According to an aspect of the invention, the non-sticky layer is formed by a sol-gel method.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a perspective view illustrating a bread maker to which a baking tray according to the present invention is applied.

FIG. 2 is an enlarged perspective view of the baking tray of FIG. 1;

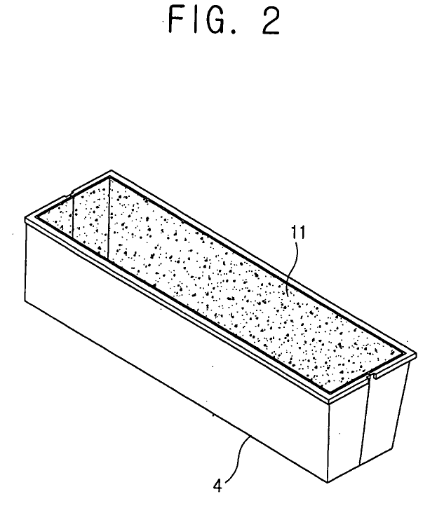

FIG. 3 is a sectional view of the baking tray formed with a non-sticky ceramic layer according to the present invention.

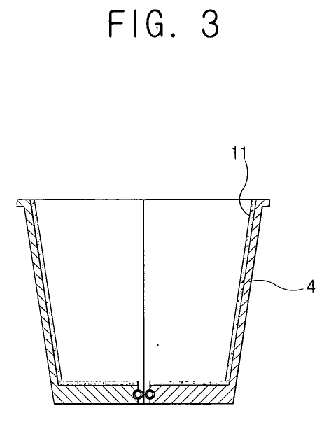

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

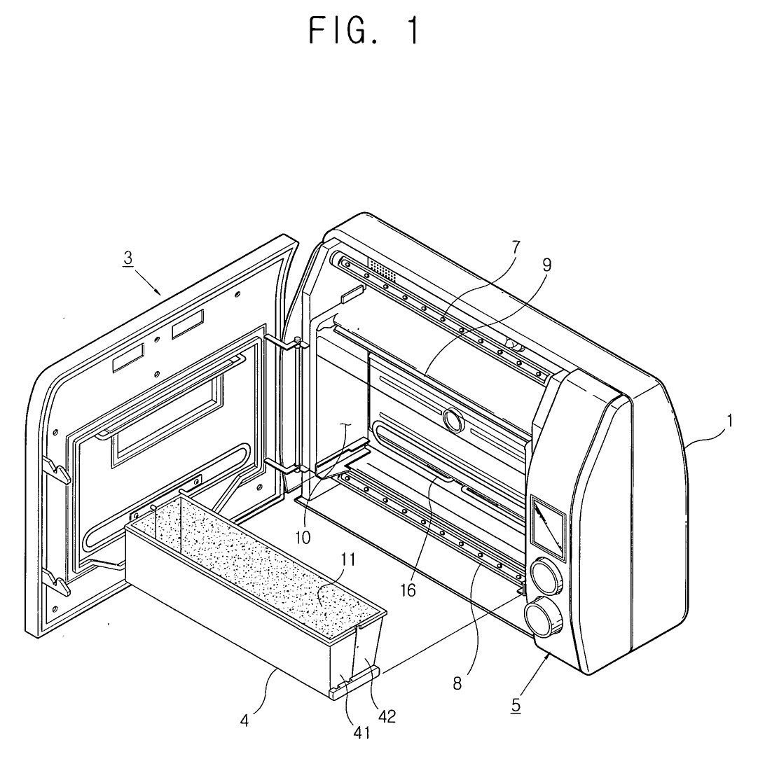

FIG. 1 is a perspective view of a bread maker provided with a baking tray 4 according to the present invention. As shown in FIG. 1, the bread maker comprises: a main body 1 provided with an oven compartment 10; a door 3 to rotatably open and close a front opening of the oven compartment 10; and an operation display panel 5 in a front side of the main body 1 to display an operation state of the main body 1.

Upper and lower kneading drums 7 and 8, which are disposed in parallel to wind upper and lower ends of a mixing bag (not shown) filled with raw materials to make bread in clockwise and counterclockwise directions, are placed in upper and lower parts inside of the oven compartment 10. Between the upper and lower kneading drums 7 and 8 is placed a pair of dough-blocking members 9 preventing the raw materials kneaded in the mixing bag from being moved toward the upper kneading drum 7.

In a lower part of the oven compartment 10, a baking tray 4 which slides out of the oven compartment 10 and contains the kneaded materials for bread therein is provided between the upper and lower kneading drums 7 and 8.

The baking tray 4 has a box shape having a top opening by combining first and second tray members 41 and 42 of an approximately “L” shaped section symmetrical to each other. A slit is formed at the bottom of the baking tray 4 by the first and second tray members 41 and 42. A non-sticky ceramic layer 11 is coated inside of the baking tray 4.

The ceramic layer 11 is made by a sol-gel method. Generally, the sol-gel method is performed as follows. At first, a colloidal solution, i.e., sol, is formed. The sol is made of solid particles of a diameter of a few hundred μm suspended in a liquid state. Then, the particles condense in a new phase, i.e., gel in which a solid macromolecule is immersed in a liquid phase. The gel, which is obtained in the above-described process, is changed into an inorganic reticular structure. Thereafter, a drying process and a heat-treatment process are followed, which transforms the gel into the ceramic.

Now, the method of coating a surface of the baking tray 4 with the non-sticky ceramic layer 11 will be described. At first, impurities on the surface of the baking tray 4 on which the non-sticky ceramic layer 11 is to be coated are removed by a sanding-process or an etching-process. Then, the surface of the baking tray 4 is cleaned with a predetermined cleaner. Coating material desired to coat the surface is preheated at about 70° C. and then applied on the surface of the baking tray 4 by a well-known spray method. Thereafter, a sintering process at about 70° C. is followed for about 30 minutes, so that the non-sticky ceramic layer 11 is formed on the surface of the baking tray 4.

In the sintering process, time for sintering is varied according to a setting temperature. Generally, at the temperature of 90° C., it takes about 60 minutes for sintering and at the temperature of 180° C., it takes about 20 minutes for sintering.

With this configuration, one end of the mixing bag is wound by the upper kneading drum 7. Then, the other end of the mixing bag passes through the pair of dough-blocking members 9 and the slit formed at the bottom of the baking tray 4 and then is wound by the lower kneading drum 8. The mixing bag filled with raw materials to make bread is reciprocated up and down by the upper and lower kneading drums 7 and 8 during a kneading process, so that the raw materials to make bread are kneaded between the pair of dough-blocking members 9 and the baking tray 4. Thereafter, the mixing bag is removed and the raw materials to make bread contained in the baking tray 4 are baked by the baking heater 16.

Here, when the mixing bag filled with raw materials to make bread is moved down, it strikes the baking tray 4 forcefully and gives an impact on the lower surface of the baking tray 4. However, this impact can be absorbed by the non-sticky ceramic layer 11 having good abrasion resistance.

In the above-described embodiment, the ceramic layer is formed by the sol-gel method. However, other methods known in the art such as a vacuum coating, a chemical vapor deposition, a dipping and an electrodeposition coating may be applied.

As described above, according to the present invention, the baking tray in which impact given by the mixing bag moved up and down can be absorbed and which is more sanitary is offered.

Although a few embodiments of the present invention have been shown and described, it will be appreciated by those skilled in the art that changes may be made in these embodiments without departing from the principles and spirit of the invention, the scope of which is defined in the appended

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A baking tray to be used in a bread maker, the baking tray having surfaces coated with a non-sticky ceramic layer.

2. The baking tray according to claim 1, wherein the non-sticky ceramic layer is coated on an inner surface of the baking tray.

3. The baking tray according to claim 1, wherein the non-sticky layer is formed by a sol-gel method.

4. The baking tray according to claim 2, wherein the non-sticky layer is formed by a sol-gel method.

5. A bread maker in which dough is kneaded by reciprocating a mixing bag up and down, comprising:
an oven compartment;
a pair of parallel kneading drums which are rotatably disposed in upper and lower parts of the oven compartment and rotated in clockwise and counterclockwise directions;
a baking tray, having a ceramic layer to receive the dough to bake bread, wherein the baking tray is placed between the upper and lower kneading drums and formed with a slit;
a pair of dough-blocking members which is disposed in an upper part of the oven compartment between the baking tray and the upper kneading drum and prevents the mixing bag from being moved toward the upper kneading drum;
a heater to heat the inside of the oven compartment;
a rotation sensor sensing rotations of the upper and lower kneading drums;
a driving part rotating the upper and lower kneading drums; and
a control part controlling a rotation of the upper and lower kneading drums.

6. The bread maker according to claim 5, further comprising:
a door to rotatably open and close a front opening of the oven compartment; and
an operation display panel in a front side of the main body to display an operation state of the main body.

7. The bread maker according to claim 5, wherein the upper and lower kneading drums are disposed in parallel to wind upper and lower ends of the mixing bag.

8. The bread maker according to claim 5, wherein the baking tray slides into and out of the oven compartment.

9. The bread maker according to claim 5, wherein the baking tray is shaped like a box, and includes an opening in the top surface.

10. The bread maker according to claim 5, wherein the ceramic layer is formed by a sol-gel method.

11. The bread maker according to claim 5, wherein the ceramic layer is formed by a vacuum coating method.

12. The bread maker according to claim 5, wherein the ceramic layer is formed by a chemical vapor deposition method.

13. The bread maker according to claim 5, wherein the ceramic layer is formed by an electrodeposition method.

14. A bread maker to make bread, including a heater to heat the inside of the oven compartment, a rotation sensor sensing rotations of the upper and lower kneading drums, a driving part rotating the upper and lower kneading drums, and a control part controlling a rotation of the upper and lower kneading drums, in which dough is kneaded by reciprocating a mixing bag up and down inside an oven compartment, comprising:
a pair of parallel kneading drums which are rotatably disposed in upper and lower parts of the oven compartment and rotated in clockwise and counterclockwise directions;
a baking tray, having a ceramic layer to receive the dough to bake bread, wherein the baking tray is placed between the upper and lower kneading drums and formed with a slit; and
a pair of dough-blocking members which is disposed in an upper part of the oven compartment between the baking tray and the upper kneading drum and prevents the mixing bag from being moved toward the upper kneading drum.

15. The bread maker according to claim 14, further comprising:
a door to rotatably open and close a front opening of the oven compartment; and
an operation display panel in a front side of the main body to display an operation state of the main body.

16. The bread maker according to claim 14, wherein the upper and lower kneading drums are disposed in parallel to wind upper and lower ends of the mixing bag.

17. The bread maker according to claim 14, wherein the baking tray slides into and out of the oven compartment.

18. The bread maker according to claim 14, wherein the baking try is shaped like a box, and includes an opening in the top surface.

19. The bread maker according to claim 14, wherein the ceramic layer is formed by a sol-gel method.

20. The bread maker according to claim 14, wherein the ceramic layer is formed by a vacuum coating method.

21. The bread maker according to claim 14, wherein the ceramic layer is formed by a chemical vapor deposition method.

22. The bread maker according to claim 14, wherein the ceramic layer is formed by an electrodeposition method.
